(19) United States
(12) Patent Application Publication
(10) Pub. No.: US 2025/0224887 A1
(43) Pub. Date: Jul. 10, 2025

(54) VOLTAGE-ADAPTIVE MEMORY

(71) Applicant: Wiliot, Ltd., Caesarea (IL)

(72) Inventors: Sagi KUPFERMAN, Herzliya (IL); Shahar PORAT, Ein Carmel (IL)

(73) Assignee: Wiliot, Ltd., Caesarea (IL)

(21) Appl. No.: 18/405,412

(22) Filed: Jan. 5, 2024

(51) Int. Cl. G06F 3/06

(52) U.S. Cl. CPC G06F 3/0625; G06F 3/0634; G06F 3/0673

(57) ABSTRACT

According to a first aspect of the present disclosed subject matter, voltage-adaptive static random-access memory (SRAM) comprising: at least one-bit SRAM cell having address, data and control buses; and a memory controller configured to determine operation modes and control voltage to a power rail of the at least one-bit SRAM cell based on an operation mode of the operation modes.

### TECHNICAL FIELD

The present disclosed subject matter generally relates to volatile memory. More particularly, the present disclosed subject matter relates to Static Random Access Memory (SRAM) operating at low power levels.

### BACKGROUND

Nonvolatile memory, such as Magneto Resistive-Random Access Memory (M-RAM), Ferroelectric-RAM (Fe-RAM), Read-Only Memory (ROM), Programable-ROM (PROM), Erasable-PROM (EPROM), and Flash memory preserves data in the absence of electrical voltage.

In contrast, volatile memory, exemplified by Random Access Memory (RAM), requires continuous power to retain data. RAM acts as short-term memory, aiding quick CPU access during active tasks. Its temporary nature means data is lost on power loss, requiring reloading from nonvolatile storage. Vital for rapid task execution, volatile memory isn't suited for Iong-term data storage, a role fulfilled by nonvolatile technologies like hard drives and flash memory. Two primary RAM types, Dynamic Random Access Memory (DRAM) and Static Random Access Memory (SRAM), differ fundamentally in architecture, performance, and application.

DRAMs are organized in a capacitor matrix and require periodic refreshing to maintain data, whereas SRAM is constructed of transistors. SRAM doesn't need refreshing, offering faster access and lower latency, but requires more physical space and is thus more costly. In general, DRAM consumes less power compared to SRAM, especially in standby mode, as it requires less power to maintain stored data. SRAM typically consumes more power than DRAM due to its more complex circuitry and constant power requirement for data maintenance.

Power consumption issues of devices in general, and their SRAM in particular, are crucial, particularly in battery-powered devices, battery-free devices, and energy harvesting devices, such as IoT tags. These devices also utilize low-power radio ICs that remain active in continuous wireless communication with mobile devices, highlighting the importance of low average power consumption.

Commercially available ultra-low-cost IoT tags also eliminate reference components like a crystal device. Instead, over-the-air clock and carrier recovery methods are employed to calibrate integrated oscillators, fulfilling BLE (Bluetooth Low Energy) standards. Reducing energy consumption becomes advantageous where there's either a limited energy source or a need for charging between operations for the IoT tag.

It would, therefore, be the objective of the present disclosure to provide a solution that addresses energy budget management challenges for SRAM, as noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

According to a first aspect of the present disclosed subject matter, voltage-adaptive static random-access memory (SRAM) comprising at least one-bit SRAM cell having address, data, and control buses; and a memory controller configured to determine operation modes and control voltage to a power rail of the at least one-bit SRAM cell based on an operation mode of the operation modes.

In some exemplary embodiments, the memory controller utilizes a control logic to determine the operation modes based on address, data, and control buses inputs; and a DC supply level available to the voltage-adaptive SRAM.

In some exemplary embodiments, the operation modes comprising an active mode; a retention mode; and a brownout mode.

In some exemplary embodiments, the memory controller further comprises; a brownout detector; a check-valve; a safe-mode circuit; an active-switch; and a retention-switch.

In some exemplary embodiments, during the active-mode the memory controller engages the active-switch for routing a VDDdig voltage to the power rail of the at least one-bit SRAM cell to enable read-write operations.

In some exemplary embodiments, during the retention mode the memory controller engages the retention-switch for routing a VDDaon voltage to the power rail of the at least one-bit SRAM cell to conserve energy while retaining vital information and maintaining necessary functionalities in a low DC supply level.

In some exemplary embodiments, during a brownout-mode the memory controller blocks the at least one-bit SRAM cell to prevent current leakage and inhibit inrush current through the at least one-bit SRAM cell.

In some exemplary embodiments, the address, data and control buses are maintained at a logic zero in a brownout mode.

In some exemplary embodiments, the brownout detector together with the safe mode circuit are configured to detect an unsafe voltage threshold and isolate the memory data bus once the threshold surpassed.

In some exemplary embodiments, the memory unsafe circuit facilitates memory retention at a DC supply level below 200 millivolts.

In some exemplary embodiments, the check-valve prevents current flowing from the power rail to the DC supply and facilitates low voltage drop between VDDaon and the power rail.

According to another aspect of the present disclosed subject matter, an internet of tings (IoT) device comprising: the system-on-a-chip (SoC); a transceiver supporting a short-range communication protocol for communicating with other IoT devices; and a power supply based on radio frequency (RF) energy harvester.

In some exemplary embodiments, the SoC comprises: a processor; an input and output module; and voltage-adaptive static random-access memory (SRAM) comprising: at least one-bit SRAM cell having address, data and control buses; and a memory controller configured to determine operation modes and control voltage to a power rail of the at least one-bit SRAM cell based on an operation mode of the operation modes.

In some exemplary embodiments, the memory controller utilizes a control logic to determine the operation modes based on address, data, and control buses inputs; and a DC supply level available to the SoC, wherein the operation modes comprising an active mode, a retention mode; and a brownout mode.

In some exemplary embodiments, the memory controller further comprises; a brownout detector; a check-valve; a safe-mode circuit; an active-switch; and a retention-switch.

In some exemplary embodiments, during the active-mode the memory controller engages the active-switch for routing a VDDdig voltage to the power rail of the at least one-bit SRAM cell to enable read-write operations.

In some exemplary embodiments, during the retention mode the memory controller engages the retention-switch for routing a VDDaon voltage to the power rail of the at least one-bit SRAM cell to conserve energy while retaining vital information and maintaining necessary functionalities in a low DC supply level.

In some exemplary embodiments, during a brownout-mode the memory controller blocks the at least one-bit SRAM cell to prevent current leakage and inhibit inrush current through the at least one-bit SRAM cell, and wherein the address, data and control buses are maintained at a logic zero.

In some exemplary embodiments, the brownout detector together with the safe mode circuit are configured to detect an unsafe voltage threshold and isolate the memory data bus once the threshold surpassed, and wherein the memory unsafe circuit facilitates memory retention at a DC supply level below 200 millivolts.

In some exemplary embodiments, the check-valve prevents current flowing from the power rail to the DC supply and facilitates low voltage drop between VDDaon and the power rail.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosure will be apparent from the following detailed description taken in conjunction with the accompanying drawings.

In the drawings:

FIG. 1 shows a block diagram of a voltage-adaptive Static Random Access Memory (SRAM) module in accordance with some exemplary embodiments of the disclosed embodiments; and

FIG. 2 shows a block diagram of an SoC (System-on-a-Chip) based network-connected device, in accordance with some exemplary embodiments of the disclosed embodiments.

### DETAILED DESCRIPTION

The embodiments disclosed herein are only examples of the many possible advantageous uses and implementations of the innovative teachings presented herein. In general, statements made in the specification of the present application do not necessarily limit any of the various claimed embodiments. Moreover, some statements may apply to some inventive features but not to others. In general, unless otherwise indicated, singular elements may be plural and vice versa with no loss of generality. In the drawings, like numerals refer to like parts through several views.

One objective of the present disclosure is reducing the energy consumption of Memory banks, i.e., SRAM, which proves to be mandatory for devices with a limited energy source or the need for charging between operations, such as an IoT tag. Such devices' operation time can be categorized into three general states: Active, Retention, and Brownout.

In the Active state, devices perform tasks, such as read-write, that consume relatively higher energy due to their functional state. In the Retention state, devices transition into a Retention-Mode, aiming to conserve energy while retaining vital information or maintaining specific functionalities in a low-power state. In a Brownout state, the device experiences a drop or reduction in power supply below the normal operating levels, leading to decreased performance or system instability.

Another objective of the present disclosure is reducing the operation time during an Active-Mode due to its inherently energy-demanding nature. It is also advantageous to minimize energy consumption in the Retention state while extending the duration of the Retention-Mode before encountering the Brownout state, where minimizing self-current is the goal. It should be noted that Information stored in SRAM is erased during Brownout state.

One technical solution incorporated in the SRAM of the present disclosure is ultra-low-leakage and mask memory bit output for all memory blocks in the Brownout state. Another technical solution incorporated in the SRAM of the present disclosure is ultra-low-leakage and maintaining the ability to retain bits at ultra-low-voltages in the Retention-Mode. Yet another technical solution incorporated in the SRAM of the present disclosure is maintaining low latency for read & write operation in the Active-Mode.

In some exemplary embodiments, the SRAM of the present disclosure performs power management acts that support various operational states by performing the following acts: blocking memory leakage during a Brownout-Mode to prevent inrush current; creating a voltage ladder to facilitate read/write operations, and enhance their speed in the Active-Mode; and providing low voltage to memory bit cells to retain memory data during the Retention-Mode.

In some exemplary embodiments, the SRAM of the present disclosure may be configured to maintain all control bits (data, address, enable) at logic ‘0’ to safeguard information during the Retention-Mode. Additionally, or alternatively, the SRAM of the present disclosure incorporates a memory failure detection circuit enabling operation at the lowest possible voltages.

It should be noted that the SRAM of the present disclosure supports software-specific, hardware-specific, and retention-specific memory functionalities. In some exemplary embodiments, the hardware-specific memory functionality enables direct interface with hardware circuits of a System on Chip (SOC), thereby conserving valuable clock cycles and reducing energy consumption.

Moreover, the hardware-specific memory functionality may be tailored to interface with necessary hardware circuits during the Retention-Mode. For instance, it could provide calibrated system clock values and indicate the energy level required to activate other system components.

In some exemplary embodiments, the power management activities are configured to provide necessary voltage levels for all bit cells and enable transitions between modes. When low latency is needed, memory is provided with a high supply voltage, while low-supply voltage is provided for low power consumption. In the case of the first supply ramp or a brownout condition, the inrush current is blocked to minimize self-current.

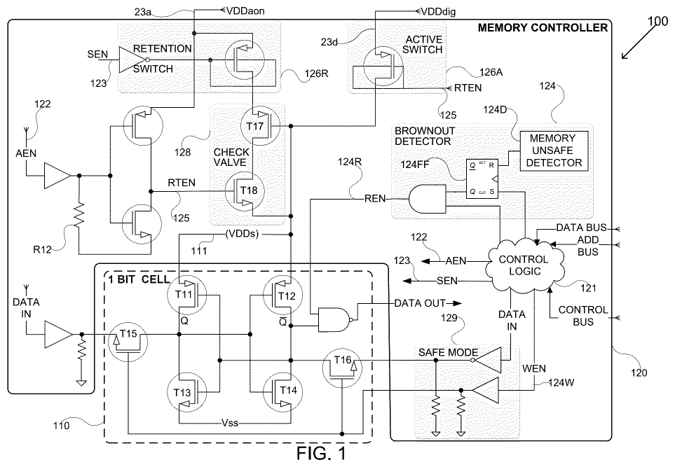

FIG. 1 shows a block diagram of a Voltage-adaptive SRAM module VA-SRAM 100, in accordance with some exemplary embodiments of the disclosed embodiments.

It should be noted that VA-SRAM 100 is designed to be used by a host processor as a data and program memory through address, data, and control buses.

In some exemplary embodiments, VA-SRAM 100 may be utilized as a CPU-centric software interface memory. Additionally, it can function as hardware support for direct operations, conserving clock cycles and energy. This includes acting as retention-specific memory and supporting vital hardware functions during low-power modes by supplying calibrated system clock values and energy activation indicators for other system components.

In some exemplary embodiments, VA-SRAM 100 is configured to retain information at ultra-low voltage levels and sustain low-latency read/write cycles in Active-Mode. In some exemplary embodiments, VA-SRAM 100 facilitates the necessary voltage levels for all memory transitions between modes: supplying high voltage for low-latency demands, low voltage for reduced power consumption, and preventing inrush current during initial supply ramp-up or brownout conditions to maintain minimal self-current.

VA-SRAM 100 may be constructed of a plurality of one-bit SRAM cells combined to form an SRAM-Array 110, and a Memory Controller 120 specifically designed to control the SRAM-Array 110 and manage its power budget. It should be appreciated that for the sake of simplifying the description, FIG. 1 depicts a single-bit SRAM cell that essentially represents a full-size SRAM-Array 110 that has memory capacity equivalent to commercially available SRAM Integrated Circuits (IC).

Additionally, it should be noted that VA-SRAM 100 of the present disclosure can be provided as an independent (standalone) IC (chip) or integrated into various semiconductor systems such as an SoC, a Central Processing Unit (CPU), a microprocessor, an Integrated Circuit (IC), a Digital Signal Processor (DSP), a microcontroller, a field-programmable gate array (FPGA), an application-specific integrated circuit (ASIC), or any combination thereof.

In some exemplary embodiments, the SRAM-Array 110 is composed of a plurality of one-bit SRAM cells made of multiple transistors arranged in a flip-flop configuration. These cells are organized in a grid-like pattern where rows and columns intersect, forming an array. Each individual SRAM cell within the SRAM-Array 110 stores a single bit of data. The memory capacity of the VA-SRAM 100 is determined by the size of the SRAM-Array 110.

In some exemplary embodiments, the one-bit SRAM cell includes six transistors of complementary metal-oxide-semiconductor (CMOS). Among these, four transistors (T11 through T14) are arranged in a cross-coupled latch configuration, forming two cross-coupled inverters. The remaining two transistors (T15 and T16) are utilized to control read and write operations, facilitating access to the data stored in the cell.

It will be noted that the term ‘bit cell’ is used loosely in this description and encompasses a bit cell, a plurality of bit cells within the SRAM-Array 110 and the SRAM-Array 110 in general.

Memory Controller 120 may include a Control Logic 121, a Brownout Detector 124, a Check-Valve 128, a Safe-Mode Circuit 129, and a Selector 126, which is composed of an Active-Switch 126A, and a Retention-Switch 126R.

In the Active-Mode, VA-SRAM 100 routes VDDdig 23d to SRAM-Array 110 by engaging Active switch 126A, thereby enabling read-write operations that demand relatively higher energy due to their functional state.

In the Retention-Mode, VA-SRAM 100 directs VDDaon 23a to SRAM-Array 110 by engaging Retention Switch 126R. This transition conserves energy while retaining vital information or maintaining specific functionalities in a low-power state.

During a Brownout-Mode, VA-SRAM 100 experiences a drop or reduction in power supply below the minimal operating levels, resulting in decreased performance or system instability.

During Brownout-Mode Memory Controller, 120 Blocks bit cells to prevent leakage, thereby inhibiting inrush current. In some exemplary embodiments, an inrush current occurs within a bit cell, flowing through T11 and T13 as well as T12 and T14, drawing a significant amount of current from the power supply when the bit cell is in an undefined state, specifically when Q equals Q̅, i.e., Q=Q̅=˜VDDs/2. In this undefined state, both sets of bit cell inverters (T11 T13 and T12 T14) consume a relatively high current, within the range of a few microamperes per bit cell, consequently creating an energy gap that may deplete/disable the power supply.

To prevent in-rush current during the initial power supply ramp, Retention Switch 126R can be utilized to obstruct VDDaon 23a from reaching an SRAM Power Rail (VDDs) 111. In some exemplary embodiments, preventing in-rush current is achieved by setting SRAM Enable (SEN) 123 to logic “0”, thereby turning Retention Switch 126R off and maintaining VDDs 111 at 0V or floating.

In some exemplary embodiments, Control-Logic 121 is utilized by Memory Controller 120 to control (adjust) the SRAM Power Rail (VDDs) 111 voltage as a function of power available to VA-SRAM 100. Control-Logic 121 is also used to determine and manage Active, Retention, and Brownout modes with SEN 123 and Active Enable (AEN) 122 signals. Additionally, or alternatively, Control-Logic 121 may be used to handle the read/write procedures during ACTIVE mode by DATA_IN, Write Enable (WEN) 124 W, and Read Enable (REN) 124R signals.

In some exemplary embodiments, Control-Logic 121 may determine the modes, i.e., Active, Retention, and Brownout modes, based on information obtained through address, data, and control buses.

During the first Active-Mode, Control Logic 121 uses AEN 122 signal to turn Active-Switch 126A on, and the bit cell may be exposed to a fast in-rush current followed by WEN 124 W, which will instigate a write a procedure that will put the bit cell in the legal position of Q=Qn!. In this legal position, the bit cell leakage is very low.

In certain exemplary embodiments, Memory Controller 120 is configured to generate higher DC voltages to enhance memory speed during read and write operations in Active-Mode. Within this Active-Mode, the Active Switch 126A may be activated, elevating VDDs 111 to 500 mV, consequently facilitating rapid bit cell switching during write procedures. In these exemplary Active-Mode setups, the Check-Valve 128 serves to prevent a reverse current of VDDs 111 from reaching VDDaon 23a voltage. Notably, AEN 122, of Control Logic 121, triggers the Retention-Enable signal (RTEN) 125 to deactivate, thereby switching on the Active Switch 126A.

In some exemplary embodiments, low voltage may be provided to bit cells in order to hold memory data and reduce leakage during Retention-Mode. During Retention-Mode, Control Logic 121 turns off VDDdig 23d, while a pull-down resistor R12 maintains AEN 122 at 0V. As a result, RTEN 125 is set to logic ‘1’, causing the Active Switch 126A to go “off” Concurrently, Check-Valve 128 facilitates a low voltage drop, typically represented by the multiplication of current by resistance, (I*R) (<10 mV) between VDDaon 23a and VDDs 111. Consequently, VDDs 111 remains close to VDDaon 23a, at approximately 290 mV. The off state of Active Switch 126A prevents reverse leakage from VDDs 111 to VDDdig 23d. This setup enables bit cells to retain data within the memory, exhibiting ultra-low self-leakage.

In certain exemplary embodiments of the Retention-Mode, Check-Valve 128 is configured to allow current flow only if VDDaon 23a voltage exceeds VDDs 111 voltage. This voltage aligns VDDs 111 voltage with VDDaon 23a voltage, causing both T17 and T18 to turn on, resulting in a low IR drop. However, during Active-Mode, when VDDs 111 voltage surpasses VDDaon 23a voltage, T17 and T18 are effectively turned off, thereby preventing reverse current from flowing from VDDs 111 to VDDaon 23a.

In some exemplary embodiments, during Brownout-Mode, the address, data, and control buses of SRAM-Array 110 are maintained at a logic zero. It should be noted when VDDs 111 drops below 200 mV, some bit cells might lose their stored data due to poor transistor Ion/Ioff, mismatch, and thermal noise. In these exemplary embodiments, a Brownout Detector 124, including a Power Memory Unsafe Detector 124D and an SR-FF 124FF together with Safe-Mode Circuit 129, may be used to detect an unsafe voltage threshold and isolate the memory data once this limit is surpassed.

Upon detection, an SR-FF 124FF will be reset, causing all bit cells data outputs to be disregarded and reset to the default logic “1” until WEN 124 W is activated, subsequently setting the SR-FF 124FF and allowing memory data to be reflected once again on Data out. Memory Unsafe Detector 124D can be implemented using a low-power voltage detector, and/or a bit cell with embedded hysteresis (i.e., biased bit cell), designed to detect self-data loss before the data loss of all other regular bit cells within SRAM-Array 110.

In certain exemplary embodiments, the Memory Unsafe Detector 124D facilitates memory retention at a lowest possible voltage. During Retention-Mode, when VDDs=200 mV, it becomes imperative to maintain WEN 124 W and Data In at 0V to ensure the bit cell's ability to retain data. Under such circumstances, certain components of Control Logic 121 might be inactive, leading to uncertain outputs. In these exemplary embodiments, the Safe-Mode Circuit 129 employs pull-down resistors to maintain the logic outputs at Tri-State, effectively holding WEN 124 W and Data In at 0V for optimal memory retention.

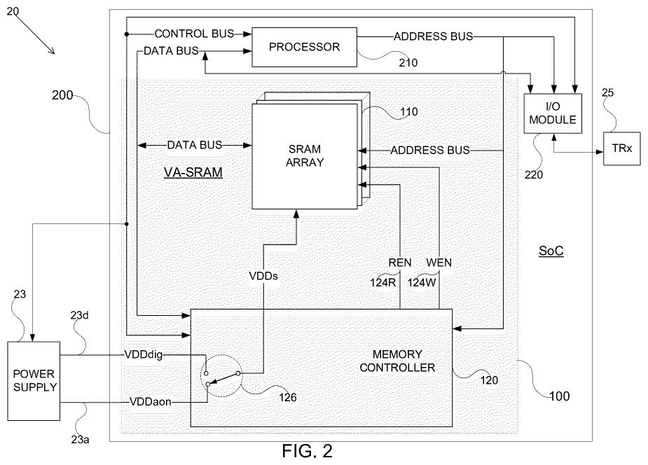

FIG. 2 shows a block diagram of an SoC-based network-connected Device 20, in accordance with some exemplary embodiments of the disclosed embodiments.

Device 20 is a network-connected device that includes a hardware system where all or most of the necessary electronic components and functionalities required for a particular application or purpose may be integrated into a single chip.

Device 20 may be a computerized system/device integrated into vehicles, appliances, machinery, or any supervised and/or controlled equipment. In certain exemplary embodiments, Device 20 may be embedded with sensors, software, actuators, and connectivity that allow it to connect, collect, and exchange data.

In some exemplary embodiments, Device 20 may be an SoC-based Internet of Things (IoT) device capable of communicating and exchanging data with other devices or systems via various networks, including the Internet, Wi-Fi, Bluetooth, cellular networks, or other communication protocols.

In some exemplary embodiments, Device 20 may include a Power-Supply 23, a Transceiver (TRx) 25, and an SoC 200. Power-Supply 23 may be used to store electrical energy for the operation of Device 20. In some exemplary embodiments, Power-Supply 23 may be an AC powered DC power supply, at least one battery, at least one chargeable battery. Additionally, or alternatively, Power-Supply 23 may include at least one capacitor charged by a harvester (not shown), which captures ambient radio frequency (RF) energy, converting it into usable DC electrical power from RF sources such as Wi-Fi, cellular networks, and other environmental electromagnetic signals.

In some exemplary embodiments, Power-Supply 23 is configured to regulate the DC power into multiple voltage levels required for the operation of SoC 200 and its subcomponents. Additionally, or alternatively, Power-Supply 23 generates a digital DC voltage supply (VDDdig 23d) for powering digital components and an ‘always on’ DC voltage supply (VDDaon 23a) used for the Complementary Metal-Oxide-Semiconductor (CMOS) technology, of which VA-SRAM 100 is made.

In some exemplary embodiments, TRx 25 may be a communication physical layer adapter configured to receive and transmit data signals between Device 20 and other network elements. TRx 25 may be used to transfer information across a network utilizing physical layers such as Ethernet cables, coaxial cables, telephone lines, fiber optic cables, wireless communication (e.g., Wi-Fi), or any combination thereof. In some exemplary embodiments, TRx 25 is coupled with an antenna (not shown) specialized in receiving and/or transmitting radio-frequency (RF) signals within the 2.4 to 2.5 Gigahertz (GHz) range, such as Bluetooth Low Energy (BLE) communication. Additionally, or alternatively, the antenna (not shown) can be used to capture RF signals across multiple RF bands beyond the BLE range for electromagnetic energy harvesting.

SOC 200's design integrates Device 20's vital components into a single chip, minimizing size, cost, and power usage. This facilitates network participation and intended functionalities. In certain exemplary embodiments, SOC 200 serves as a core component supporting diverse IoT applications.

In some exemplary embodiments, SoC 200 may include a Processor 210, an I/O module 220, and a VA-SRAM 100.

Processor 210 can be implemented as firmware written for or ported to a specific processor, such as a Digital Signal Processor (DSP) or an application-specific integrated circuit (ASIC). In some exemplary embodiments, Processor 210 may be a Processing Unit (CPU), a microprocessor utilized to perform computations required by SoC 200 or any of its subcomponents. In some exemplary embodiments, Processor 210 is partitioned into multiple power domains. Each power domain is a collection of gates powered by the same power and ground supply. To reduce power consumption, only one power domain is turned on during execution. Processor 210 can perform functions, such as memory read/write, interface with input-output components, executing logic operations, tracking the power level of Power-Supply 23; generating and preparing data packets for transmission; cyclic redundancy check (CRC) code generation; packet whitening; encrypting/decrypting and authenticating packets; converting data from parallel to serial; and staging the packet bits to the analog transmitter path for transmission.

In some exemplary embodiments, I/O Module 220 is utilized as an interface between Processor 210 and TRx 25, facilitating communication over physical layers with other network elements to enable information exchange across the network.

I/O Module 220 functions as a port that empowers Processor 210 to execute various functions, facilitating communication through a low-power protocol. Such protocols include, but are not limited to, Bluetooth®, LoRa, Wi-Gi®, nRF, DECT®, Zigbee®, Z-Wave, EnOcean, and others. In a preferred embodiment, Processor 210 operates using a Bluetooth Low Energy (BLE) communication protocol.

In some exemplary embodiments, SOC 200 may include a VA-SRAM 100 (Voltage-Adaptive Static Random Access Memory). In some exemplary embodiments, VA-SRAM 100 may retain data and program code intended to cause Processor 210 to independently carry out processes associated with the operation of Device 20 in general and SoC 200 in particular. Additionally, or alternatively, VA-SRAM 100 may be utilized as a software-specific memory, hardware-specific memory, and retention-specific memory.

Software files retained by VA-SRAM 100 may be implemented as one or more sets of interrelated computer instructions, executed, for example, by Processor 210 or by another processor. The files may be arranged as one or more executable files, dynamic libraries, or static libraries.

In some exemplary embodiments, VA-SRAM 100 may be utilized in devices with a limited or unstable DC power source or a requirement for charging between operations. Such devices, which can include IoT tags (but are not limited to them), rely on batteries or RF-harvested power and require memory operation to be categorized into three general modes: Active, Retention, and Brownout. Additionally, or alternatively, VA-SRAM 100 is optimized to subthreshold or near-threshold voltage, e.g., 0.2V-0.5V, to allow for the reduction of the leakage of the retention cells.

It should be noted that VA-SRAM 100 may be implemented either as an integral part of SoC 200, i.e., a same semiconductor chip or as an independent integrated circuit, i.e., a standalone semiconductor chip (not shown).

It should also be noted that in either, mentioned above implementation VA-SRAM 100 is an independent hardware unit that serves processing units, however, not managed by them, i.e., external controllers. That is to say, that VA-SRAM 100 is configured to pass data words, obtain address word, and control bits indicating read or write request form a host processor such as Processor 210.

In some exemplary embodiments, the SRAM-Array 110 is composed of a plurality of SRAM cells made of multiple transistors arranged in a flip-flop configuration. These cells are organized in a grid-like pattern where rows and columns intersect, forming an array. Each individual SRAM cell within the SRAM-Array 110 stores a single bit of data. The memory capacity of the VA-SRAM 100 is determined by the size of the SRAM-Array 110. The address bus accesses at least one SRAM cell (i.e., bit, nibble, byte, or word) within the SRAM-Array 110. This process involves storing data from the data bus or fetching data from the identified SRAM cell into the data bus based on the Memory Controller 120's WEN 124 W or REN 124R indications, respectively.

In some exemplary embodiments, Memory Controller 120 invokes the following actions to address ultra-low voltage levels and maintain low latency: a Brownout-Mode action designed to minimize leakage and mask memory bit output from continuously powering SRAM-Array 110 addresses, a Retention-Mode action is aimed at reducing leakage and enabling bit retention at ultra-low voltages, and an Active-Mode action facilitates low-latency read and write operations.

In some exemplary embodiments, Memory Controller 120 utilizes Control Logic 121 to determine Active, Retention, and Brownout modes and executes associated actions based on host requests (i.e., from Processor 210) via data, address, and control buses. In addition to monitoring VDDdig 23d and VDDaon 23a voltages supplied by Power Supply 23.

In the Active-Mode, VA-SRAM 100 routes VDDdig 23d to SRAM-Array 110 by Selector 126, thereby enabling read-write operations that demand relatively higher energy due to their functional state.

In the Retention-Mode, VA-SRAM 100 directs VDDaon 23a to SRAM-Array 110 using Selector 126. This transition conserves energy while retaining vital information or maintaining specific functionalities in a low-power state.

During a Brownout-Mode, VA-SRAM 100 experiences a drop or reduction in power supply below the minimal operating levels, resulting in decreased performance or system instability.

It should be noted that Device 20 may also include other memory modules (not shown), including volatile and/or non-volatile memories, based on semiconductor technologies such as Fe-RAM, ROM, PROM, EPROM, and Flash memory.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; A and B in combination; B and C in combination; A and C in combination; or A, B, and C in combination.

All examples and conditional language recited herein are intended for pedagogical purposes to aid the reader in understanding the principles of the disclosure and the concepts contributed by the inventor to furthering the art, and are to be construed as being without limitation to such specifically recited examples and conditions.

What is claimed is:

1. A voltage-adaptive static random-access memory (SRAM) comprising:
at least one-bit SRAM cell having address, data and control buses; and
a memory controller configured to determine operation modes and control voltage to a power rail of the at least one-bit SRAM cell based on an operation mode of the operation modes.

2. The voltage-adaptive SRAM of claim 1, wherein the memory controller utilizes a control logic to determine the operation modes based on address, data, and control buses inputs; and a DC supply level available to the voltage-adaptive SRAM.

3. The voltage-adaptive SRAM of claim 2, wherein the operation modes comprising an active mode; a retention mode; and a brownout mode.

4. The voltage-adaptive SRAM of claim 3, wherein the memory controller further comprises: a brownout detector; a check-valve; a safe-mode circuit; an active-switch; and a retention-switch.

5. The voltage-adaptive SRAM of claim 4, wherein in an active-mode the memory controller engages the active-switch for routing a VDDdig voltage to the power rail of the at least one-bit SRAM cell to enable read-write operations.

6. The voltage-adaptive SRAM of claim 4, wherein in the retention mode the memory controller engages the retention-switch for routing a VDDaon voltage to the power rail of the at least one-bit SRAM cell to conserve energy while retaining vital information and maintaining necessary functionalities in a low DC supply level.

7. The voltage-adaptive SRAM of claim 4, wherein in a brownout-mode the memory controller blocks the at least one-bit SRAM cell to prevent current leakage and inhibit inrush current through the at least one-bit SRAM cell.

8. The voltage-adaptive SRAM of claim 4, wherein the address, data and control buses are maintained at a logic zero in a brownout mode.

9. The voltage-adaptive SRAM of claim 4, wherein the brownout detector together with the safe mode circuit are configured to detect an unsafe voltage threshold and isolate a memory data bus once the threshold surpassed.

10. The voltage-adaptive SRAM of claim 4, wherein the memory unsafe circuit facilitates memory retention at a DC supply level below 200 millivolts.

11. The voltage-adaptive SRAM of claim 4, wherein the check-valve prevent current flowing from the power rail to the DC supply and facilitates low voltage drop between VDDaon and the power rail.

12. An Internet of things (IoT) device, comprising:
a system-on-a-chip (SoC);
a transceiver supporting a short-range communication protocol for communicating with other IoT devices; and
a power supply based on radio frequency (RF) energy harvester.

13. The IoT device of claim 12, wherein the SoC comprising:
a processor;
an input and output module; and
a voltage-adaptive static random-access memory (SRAM) comprising:
at least one-bit SRAM cell having address, data and control buses; and
a memory controller configured to determine operation modes and control voltage to a power rail of the at least one-bit SRAM cell based on an operation mode of the operation modes.

14. The IoT device of claim 13, wherein the memory controller utilizes a control logic to determine the operation modes based on address, data, and control buses inputs; and a DC supply level available to the SoC, and wherein the operation modes comprising an active mode; a retention mode; and a brownout mode.

15. The IoT device of claim 14, wherein the memory controller further comprises; a brownout detector; a check-valve; a safe-mode circuit; an active-switch; and a retention-switch.

16. The IoT device of claim 15, wherein in an active-mode the memory controller engages the active-switch for routing a VDDdig voltage to the power rail of the at least one-bit SRAM cell to enable read-write operations.

17. The IoT device of claim 15, wherein in the retention mode the memory controller engages the retention-switch for routing a VDDaon voltage to the power rail of the at least one-bit SRAM cell to conserve energy while retaining vital information and maintaining necessary functionalities in a low DC supply level.

18. The IoT device of claim 15, wherein in a brownout-mode the memory controller blocks the at least one-bit SRAM cell to prevent current leakage and inhibit inrush current through the at least one-bit SRAM cell, and wherein the address, data and control buses are maintained at a logic zero.

19. The IoT device of claim 18, wherein the brownout detector together with the safe mode circuit are configured to detect an unsafe voltage threshold and isolate a memory data bus once the threshold surpassed, and wherein the memory unsafe circuit facilitates memory retention at a DC supply level below 200 millivolts.

20. The IoT device of claim 15, wherein the check-valve prevent current flowing from the power rail to the DC supply and facilitates low voltage drop between VDDaon and the power rail.
